(19) United States
(12) Patent Application Publication
(10) Pub. No.: US 2008/0135490 A1
(43) Pub. Date: Jun. 12, 2008

(54) Quantum dot biolabeling and immunomagnetic separation for detection of contaminants

(75) Inventors: Yanbin Li, Fayetteville, AR (US); Xiao-Li Su, Fayetteville, AR (US); Liju Yang, West Lafayette, IN (US)

Correspondence Address: MICHAEL BEST & FRIEDRICH LLP, Two Prudential Plaza, 180 North Stetson Avenue, Suite 2000, CHICAGO, IL, 60601, US

(73) Assignee: Board of Trustees of the University of Arkansas, Little Rock, AR (US)

(21) Appl. No.: 11/328,020

(22) Filed: Jan. 9, 2006

Related U.S. Application Data
(60) Provisional application No. 60/642,356, filed on Jan. 7, 2005.
(60) Provisional application No. 60/642,336, filed on Jan. 7, 2005.

(51) Int. Cl. C02F 1/48; B03C 1/30

(52) U.S. Cl. 210/695; 436/20; 436/63; 436/86; 436/171

(57) ABSTRACT

Methods are provided for detecting, separating, isolating and quantifying contaminants in starting materials by separating the contaminant from the starting material using a bead coupled to an affinity moiety and quantum dot-labeling the contaminant. The contaminant is detected by the characteristic emission spectrum of the quantum dot. Also, competitive binding methods are provided wherein the starting material and a control material are contacted with a quantum dot coupled to an affinity moiety capable of binding the contaminant and a competitor complex. A decrease in the intensity of the characteristic emission spectrum of the quantum dot associated with the competitor complex from the starting material as compared to that of the control material is indicative of the presence of the contaminant in the starting material.

### CROSS-REFERENCE TO RELATED APPLICATIONS

This application claims priority to U.S. provisional applications 60/642,356, and 60/642,336, both of which were filed on Jan. 7, 2005. These provisional applications are incorporated herein by reference in their entireties.

### STATEMENT REGARDING FEDERALLY SPONSORED RESEARCH

The invention was made with United States government support under Grant Number USDA/CSREES 99-34211-7563 awarded by the United States Department of Agriculture. The United States government has certain rights in this invention.

### INTRODUCTION

This invention relates to methods for detecting, separating and quantifying contaminants in a variety of starting materials including, but not limited to food products, clinical samples and environmental samples.

The ability to detect the presence of small amounts of contaminants, such as bacteria, in a complex background is of vital importance to biotechnology, medical diagnosis and the fight against bioterrorism. Detection and identification of contaminants in the food or water supply is necessary to protect health and safety as many microorganisms become resistant to antibiotics and the threat of bioterrorism grows. Also, rapid detection of small numbers of contaminants will result in faster clinical diagnosis of disease, and may result in better prognosis. Detection of contaminants is difficult when only a small amount must be detected in a large sample volume or within a complex sample such as a food product or soil. There exists a need in the art for additional methods for detecting, separating and quantifying contaminants that are sensitive, specific and rapid.

A number of markers and particles useful in physical and chemical techniques have been developed. For instance, quantum dots are fluorescent semiconductor nanocrystals and represent a relatively new class of fluorescent markers. Quantum dots can be modified and used to label biologic samples as previously described by Chan and Nie, Science 281:2016-2018 (1998); Bruchez et al., Science 281:2013-2016 (1998); U.S. Pat. No. 6,326,144; and U.S. Pat. No. 6,468,808 all of which are incorporated herein by reference in their entireties. For example, proteins can be covalently attached to quantum dots and interactions of the protein with other molecules monitored by fluorescent microscopy. Quantum dots have several advantages over conventional fluorescent dyes. They have narrow emission spectra, broad absorption spectra, are photostable and the emission color is tunable by changing the size and material composition of the quantum dot core.

Beads, particularly microbeads, and more particularly magnetic microbeads, have been widely used to develop methods for separating or isolating a variety of biomolecules and contaminants from complex starting materials. In particular, immunomagnetic beads (antibody-coated) provide a specific, technically simple, rapid and efficient method of isolating a target material, such as bacteria, from starting materials without any need for centrifugation or filtration. The bacteria captured by antibody-coated beads can be detected by conventional plating, which is reliable, but generally time-consuming, requiring 18 or more hours. Some methods for rapid detection have been reported and are based on either use of enzyme or fluorescently labeled secondary antibodies followed by optical or electrochemical analysis.

Nanoparticles may be used in place of traditional microbeads in many applications. Nanoparticles range in size from 1 to 300 nm in diameter and exhibit properties of a fluid rather than a particle. Nanoparticles can be magnetic or can serve as a colorimetric label as described by Fritzsche and Taton, Nanotechnol. 14:R63-R73 (2003); Tan et al., Med. Res. Rev. 24:621-638 (2004); Zhao et al., PNAS 101:15027-15032 (2004); U.S. Pat. No. 6,623,982; and U.S. Pat. No. 6,645,731 all of which are incorporated herein by reference in their entireties. Magnetic nanoparticles do not interfere with chemiluminescence, fluorescence, PCR analysis or immunoassays. Like magnetic beads, nanoparticles can be complexed with antibodies to provide an efficient means of isolating a target material from a complex starting material.

### SUMMARY

Sensitive, specific and rapid methods for alternatively detecting, separating and quantifying contaminants from a starting material by combining bead-based separation with quantum dot based detection are described.

In one aspect, the present invention provides methods of detecting a contaminant in a starting material. The contaminant is immunomagnetically separated from the starting material. The contaminant is then immunolabeled with a quantum dot. The characteristic emission spectrum of the quantum dot is detected and analyzed.

In another aspect, the present invention provides methods for detecting a contaminant in a starting material. The method involves contacting the starting material with a bead coupled to a first affinity moiety. The first affinity moiety is capable of binding the bead with the contaminant to form a target. The target is comprised of the bead coupled to the contaminant, and is separated from the starting material. The target is then contacted with a quantum dot coupled to a second affinity moiety. The second affinity moiety is also capable of binding the contaminant of the target to form a labeled target. The labeled target is comprised of the target coupled to the quantum dot. The quantum dot has a characteristic emission spectrum. The characteristic emission spectrum of the quantum dot in the labeled target is detected and is indicative of the detection of the contaminant.

In another aspect, the present invention provides methods for quantifying the contaminants in a starting material. The method involves contacting the starting material with a bead coupled to a first affinity moiety. The first affinity moiety is capable of binding the bead with the contaminant to form a target. The target is comprised of the bead coupled to the contaminant. The target is separated from the starting material. The target is then contacted with a quantum dot coupled to a second affinity moiety. The second affinity moiety is also capable of binding the contaminant of the target to form a labeled target. The labeled target is comprised of the target coupled to the quantum dot. The quantum dot has a characteristic emission spectrum. The characteristic emission spectrum of the quantum dot in the labeled target is detected and compared to the emission spectra of a labeled target containing known numbers of contaminants in order to quantify the contaminants in the starting material.

In yet another aspect, the present invention provides kits for detecting contaminants in a starting material. The present invention also provides kits for quantifying the contaminants in a starting material.

In a further aspect, the present invention provides a competitive detection method for detecting a contaminant in a starting material. The method includes contacting the starting material containing the contaminant and a control material not containing the contaminant with a quantum dot coupled to an affinity moiety that is capable of binding the contaminant. The starting material and the control material are also contacted with a competitor complex comprised of a bead coupled to the contaminant. The association of the quantum dot with the competitor complex results in formation of a labeled competitor complex. The competitor complex and any associated quantum dot label are separated from both the starting material and the control material. Then the characteristic emission spectrum of the quantum dot associated with the competitor complex of the starting material and the control material is detected. A decrease in the intensity of the characteristic emission spectrum of the competitor complex separated from the starting sample as compared to the intensity of the characteristic emission spectrum of the competitor complex separated from the control sample is indicative of the presence of the contaminant in the starting material.

In a still further aspect, the present invention provides a competitive binding method for quantifying the amount of a contaminant in a starting material. The starting material containing a contaminant, a control material not containing the contaminant and at least one control material containing a known amount of the contaminant are contacted with a quantum dot coupled to an affinity moiety capable of binding the contaminant. The starting and control materials are also contacted with a competitor complex comprising a bead coupled to the contaminant. The association of the quantum dot with the competitor complex by the interaction of the affinity moiety with the contaminant bound to the bead results in formation of a labeled competitor complex. The competitor complex and any associated quantum dot label are separated from the starting material and the control materials. The characteristic emission spectrum of the quantum dot associated with the competitor complex is detected in the starting material, the control material not containing the contaminant and at least one control material containing a known amount of the contaminant. The intensity of the characteristic emission spectrum of the competitor complex from the starting material is compared to the intensity of the characteristic emission spectrum of the competitor complex from the control material containing a known amount of the contaminant. The intensity of the characteristic emission spectrum is indicative of the quantity of the contaminant in the starting material.

### BRIEF DESCRIPTION OF THE DRAWINGS

FIG. 1 is a schematic diagram of a fluorescent measurement system.

FIG. 2 is a schematic diagram of the principle of contaminant detection based on combination of quantum dot labeling and bead-based separation.

FIG. 3 is a schematic diagram depicting one way of coupling the affinity moiety to the quantum dot.

FIG. 4 shows fluorescence emission spectra obtained with an excitation wavelength of 473 nm and an integration time of 512 ms: (curve a) blank (PBS); (curve b) sample (10⁷ CFU/mL of E. coli O157:H7); (curve c) sample—blank; (curve d) 10-nM quantum dots. Both blank and sample were subject to immunomagnetic separation and quantum dot labeling.

FIG. 5 shows the effect of integration time on the fluorescence intensity; (curve a) sample (10⁷ CFU/mL of E. coli O157:H7); (curve b) blank; (curve c) sample—blank.

FIG. 6 shows a typical fluorescence emission spectra (after subtracting the blank) obtained for detection of E. coli O157:H7; integration time, 1024 ms.

FIG. 7 shows fluorescence intensity as a function of the concentration of E. coli O157:H7; integration time, 1024 ms. Error bars=±SDs (n=3˜5);

FIG. 8 shows the results of the specificity test. The bacterial concentrations were all 10⁶ CFU/mL. Error bars=SDs.

FIG. 9 shows a set of representative fluorescence spectra for samples containing various numbers of Salmonella in PBS.

FIG. 10 shows the relationship between Salmonella cell number in PBS and fluorescence intensity.

FIG. 11 shows the relationship between Salmonella cell number in chicken carcass wash water and fluorescence intensity with and without the presence of E. coli O157:H7 and L. monocytogenes.

FIG. 12 is a schematic representation of the method for simultaneous detection of more than one contaminant.

FIG. 13 shows representative fluorescent emission spectra obtained from samples containing no bacteria (background), (A) Salmonella typhimurium, (B) E. coli O157:H7 and (C) a mixture of the two bacteria.

FIG. 14 shows fluorescence spectra from samples containing different numbers of E. coli O157:H7 and S. typhimurium.

FIG. 15 shows that fluorescence intensity at each wavelength was a function of the concentration of the bacterial cells labeled with the QD emitting at that wavelength.

FIG. 16 shows that fluorescence intensity decreases with increasing concentration of atrazine.

### DETAILED DESCRIPTION

The development of rapid, sensitive and specific methods for detection, separation, isolation and quantification of contaminants is a challenging and important task. Such methods are necessary to ensure food safety, environmental safety and security and may aid in early diagnosis of disease resulting in better prognosis. Briefly, the present invention provides methods of detecting, separating and quantifying contaminants in a starting material and kits for performing the methods. In one embodiment of the present invention, the methods involve contacting the starting material with beads coupled to a first affinity moiety that is capable of binding to the contaminant. The beads become linked to the contaminant by the first affinity moiety to form a target, suitably a bead-affinity moiety-contaminant complex. The target may then be separated from the starting material. The target is contacted with a quantum dot conjugate. The quantum dot conjugate contains a quantum dot with a characteristic emission spectrum coupled to a second affinity moiety capable of binding the contaminant of the target to form a labeled target. The labeled target comprises the target (the bead linked to the contaminant) linked to a quantum dot via the second affinity moiety. The labeled target is detected by excitation of the quantum dot and observance of the characteristic emission spectrum. The intensity of the emission is correlated with the quantity of contaminant.

The methods may be used to detect the presence of contaminants in a wide variety of starting materials with various levels of complexity in terms of antigenic diversity, density and volume. In addition to the starting materials used in the examples below, it is reasonable to expect that contaminants can be detected in a wide variety of food, environmental and clinical samples and may include liquid, solid or materials containing a mixture of liquids and solids. The starting materials encompassed within the present invention include, but are not limited to, vegetables, fruits, ground meats, beef, poultry, sea food, dairy, water, air, soil, blood, urine, feces, swabs from the surface of skin or organs or tissue samples. Food samples may be raw or ready-to-eat. For example, a poultry product can include a chicken carcass, wash water from a chicken carcass, a deboned chicken, ground poultry meats, or poultry patties. The methods are also suitable for food or environmental inspection or clinical diagnosis. For example, the methods could be used to monitor food during processing, storage, or even once in the market.

As described in the Examples below, many types of contaminants can be detected, separated or quantified using the methods of the present invention. In the Examples, Escherichia coli O157:H7, Salmonella typhimurium and atrazine were detected. In addition to these contaminants, it is reasonable to expect that one of skill in the art can use the methods with a wide variety of potential contaminants including, but not limited to, bacteria such as Listeria monocytogenes, Campylobacter jejuni, Pseudomonas mirabilis, Salmonella species and Enterococcus species; eukaryotic cells; polypeptides, including prions and toxins; viruses; or other chemical contaminants such as pesticides or herbicides. Significantly, both live and dead cells can be detected by the methods described herein. Starting materials can be pre-treated to kill any live contaminants that may pose a health risk to a technician performing the methods.

Fluorescent semiconductor nanocrystals (known as quantum dots (QD)) are a novel and promising class of fluorescent markers with several important advantages over conventional fluorophores. These advantages include resistance to photodegradation, improved brightness, and size-dependent narrow emission spectra. QD can be excited efficiently at any wavelength shorter than the emission peak, yet will emit with the same characteristic narrow, symmetric spectrum regardless of the excitation wavelength. Therefore, many sizes of QDs may be excited with a single wavelength of light and the emission spectrum will vary with the size of the QD resulting in a tunable fluorescent marker. This feature makes it possible to detect many emission peaks simultaneously. This property makes QDs useful as fluorescent labels for multicolor imaging in complex systems.

Quantum dots suitably have a cadmium-selenium core surrounded by a zinc sulfide shell and are made using organic solvents not suitable for use in most biological applications. To make QDs suitable for use in biological systems, water-soluble and biomolecule conjugated QDs were developed. See Chan and Nie, Science 281:2016-2018 (1998); Bruchez et al., Science 281:2013-2016 (1998); U.S. Pat. No. 6,326,144; and U.S. Pat. No. 6,468,808 all of which are incorporated herein by reference in their entireties. Various QDs are commercially available. For example, several sizes of QDs having distinct emission spectra are available from Quantum Dot Corporation (Hayward, Calif.). Biological molecules, such as polypeptides, can be coupled to QDs and retain their biological activities as described below. The ability to couple biological molecules to QDs has led to the development of molecular conjugates of QDs that are suitable for use in cell biology and immunologic assays. For example, QDs have been used in immunolabeling experiments in which the QDs are coupled to antibodies and used as a fluorescent label for microscopy. Quantum Dot Corporation (Hayward, Calif.) provides QDs prepared for coupling to affinity moieties by a variety of chemical reactions, such as QDs pre-conjugated to streptavidin or Protein A. It is reasonable to expect that one of skill in the art can utilize a variety of different chemistries to couple the affinity moiety to the QD either directly or indirectly. The variously conjugated QDs are available in a variety of sizes, each having a characteristic emission spectrum.

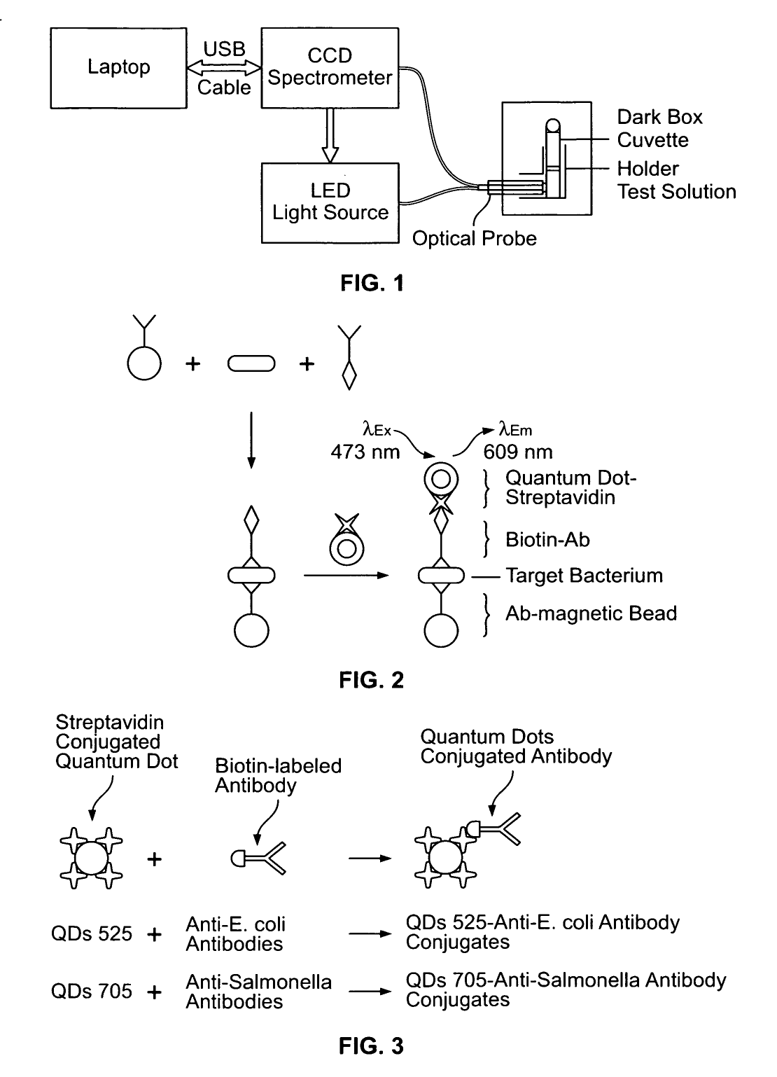

The characteristic emission spectra of QDs can be detected and recorded by a fluorescence microscope or a spectrometer. In the Examples provided below, fluorescence measurements were performed on a laptop-controlled portable system as shown in FIG. 1. The system consisted of a USB2000 miniature fiber optic spectrometer, a USB-LS-450 LED light source module, an R400-7-UV/VIS optical probe, all from Ocean Optics Inc. (Dunedin, Fla.), and a probe/cuvette holder housed in a plastic dark box. The spectrometer contained a low-cost 2048-element linear CCD-array detector with a working range of 360-900 nm. The LED module contained a blue LED, which had a spectral output peaking at 473 nm with a 27 nm-FWHM (full band width at half maximum emission intensity). The optical probe was composed of a tight bundle of 7 optical fibers in a stainless steel ferrule (6 illumination fibers around 1 read fiber, each was 400 μm in diameter). Any other spectrometer or fluorescence microscope may suitably be used as a detection system in the present invention.

Various types of beads may be utilized to separate contaminants from a starting material. As exemplified below, the beads useful in the methods can be microbeads or nanoparticles. Microbeads useful in the methods have been described. See Su and Li, Anal. Chem. 76:4806-4810 (2004), which is incorporated herein by reference in its entirety. Microbeads are available from a variety of commercial suppliers, including Dynal, Inc. (Lake Success, N.Y.). Suitably, the microbeads are between 1 and 10 μm in diameter, especially suitable are microbeads between 2 and 5 μm in diameter. Microbeads can be made of a variety of materials including, but not limited to, agarose, polystyrene, and latex. Optionally the microbeads can be magnetic, or suitably paramagnetic or superparamagnetic.

Nanoparticles are also useful for separating target materials and have previously been described. See Provisional Patent Application No. 60/642,336, filed Jan. 7, 2005; U.S. patent application Ser. No. (Attorney Docket No. 013961-9002), filed Jan. 9, 2006; and Varshney et al., J Food Protection 68:1804-1811 (2005) all of which are incorporated herein by reference in their entireties. Nanoparticles range in size from 1-300 nm in diameter, suitably from 50-150 nm in diameter. Nanoparticles can have a magnetic core that may include various metals. Nanoparticles can also include a pigmented core or a dye. See Fritzsche and Taton, Nanotechnol. 14:R63-R73 (2003); Tan et al., Med. Res. Rev. 24:621-638 (2004); Zhao et al., PNAS 101:15027-15032 (2004); U.S. Pat. No. 6,623,982; and U.S. Pat. No. 6,645,731 all of which are incorporated herein by reference in their entireties. Nanoparticles suitable for use in the methods include, but are not limited to those commercially available from Molecular Probes, Inc. (Eugene, Oreg.).

Microbeads, nanoparticles and QDs can be directly or indirectly coupled to affinity moieties having affinity for the contaminant. Beads and QDs are commercially available already prepared for coupling to affinity moieties by a variety of chemical reactions, but can also be prepared by the end-user. Beads and QDs useful in the present invention include, but are not limited to, beads and QDs pre-conjugated to streptavidin, avidin, Protein G or Protein A; kits for binding beads and QDs directly to antibodies via a covalent linkage; beads with functional carboxy or amino groups exposed on their surface for use in coupling a variety of polypeptides; or beads linked to a polypeptide (a linker) capable of binding either the Fc region of an antibody, such as an Fc receptor or anti-Fc antibody, or a non-Fc region of the antibody. Polypeptides can be biotinylated by methods well known to those of skill in the art and the biotin can form a bridging complex linking a bead or a QD to an affinity moiety by binding to streptavidin or avidin. It is reasonable to expect that one of skill in the art could utilize a variety of different chemistries to couple the affinity moiety to the beads or QDs either directly or indirectly. These same coupling methods can be used to couple a contaminant to a bead for use in a competitive assay, such as that described in Example 8.

Once the beads are contacted with the starting material and the target is formed, the bead-bound target can be separated from the starting material in a variety of ways depending on the size and type of the bead utilized. Beads can be separated by filtration, centrifugation or by generation of a magnetic field.

The QDs and the beads are able to bind to the contaminant by virtue of their coupling to an affinity moiety. Affinity moieties are suitably polypeptides that have affinity for the contaminant and will bind to the contaminant when brought into proximity with it. Affinity moieties falling within the scope of this invention include antibodies specific for the contaminant, ligands capable of binding a receptor on the contaminant, and receptors that bind to the contaminant. In addition to those affinity moieties exemplified below as useful in the methods of the present invention, it is reasonably expected that other antibodies, known to those of skill in the art, with affinity for various contaminants will be suitable in the methods of the present invention. Suitable antibodies may be identified using an antibody source guide, for example Linscott's Directory of Immunological and Biological Reagents or the MSRS Catalog of Primary Antibodies. The affinity moieties coupled to the QDs and the beads can be the same affinity moiety or different and can have distinct antigens. Methods for generating monoclonal and polyclonal antibodies are well known by those of skill in the art.

In the examples, a target bacterium was detected by the method as depicted in FIG. 2. First, magnetic beads coupled to an antibody having affinity for E. coli O157:H7 and a biotin-conjugated antibody with affinity for E. coli were mixed with the starting material. The starting material was subjected to a magnetic field and the target, comprised of the magnetic particle bound via the antibody to the E. coli which is bound to a biotinylated antibody, was separated from the starting material. The target was then mixed with quantum dot-streptavidin conjugates and subjected to a magnetic field again to separate the labeled target comprising the target coupled to the quantum dot through the interaction of the biotin on the antibody with the streptavidin on the QD. The labeled target was detected using a spectrometer. The intensity of fluorescence was indicative of the concentration of bacteria in the starting material as demonstrated by experiments in which the method was performed using known quantities of bacteria in the starting material.

The steps of the present methods can be performed in a variety of different orders. For example, the QDs can be added to the starting material before the target is separated from the starting material. Alternatively, a biotin-labeled antibody may be coupled to a streptavidin-conjugated QD prior to addition to the target as depicted in FIG. 3 and then added to the target either before or after separation from the starting material.

The labeled target resulting from the separation step of the present method may subsequently be utilized in various microbiologic, immunologic or nucleic acid based assays. For example, the contaminant can be isolated from the labeled target and either the contaminant or the labeled target (bead-affinity moiety-contaminant-affinity moiety-QD) may be subjected to assays including, but not limited to use in various biosensors, antibiotic resistance testing, ELISA assays, colony forming unit assays, histological staining, and polymerase chain reaction assays.

In addition, the present invention provides methods for performing a competitive detection assay for detecting the presence and quantifying the amount of a contaminant in a starting material. The method involves contacting the starting material containing a contaminant, and a control material that does not contain the contaminant with two compositions. The first composition comprises a quantum dot coupled to an affinity moiety. The second composition comprises a bead coupled to the contaminant to form a competitor complex. The competitor complex will compete with the contaminant in the starting material to bind the affinity moiety coupled to the quantum dot. After a period of mixing, the competitor complex with any associated QDs is separated from the starting material and the control material. The characteristic emission spectrum of the quantum dot associated with the competitor complex in both the starting material and the control material is detected. A decrease in the intensity of the characteristic emission spectrum associated with the competitor complex of the starting material as compared to the intensity of the characteristic emission spectrum associated with the competitor complex of the control material is indicative of the presence of the contaminant in the starting material. This method can also provide quantitative information if the characteristic emission spectrum of the competitor complex of the starting material is compared to the characteristic emission spectrum of the competitor complex of control samples containing known amounts of the contaminant. The amount of decrease in the intensity of the characteristic emission spectrum of the competitor complex from the starting material relative to the intensity of the emission spectrum of the competitor complex from the control is indicative of the quantity of the contaminant in the starting material.

The following examples are meant to be illustrative only and are not intended as a limitation on the concepts and principles of the invention.

### EXAMPLE 1

### Detection of E. coli O157:H7 with QD Biolabeling Coupled with Immunomagnetic Separation

Reagents. CdSe—ZnS quantum dot (QD)-streptavidin conjugates (10-15 nm in size) having a maximum emission wavelength of 609 nm (Qdot 605, Cat. #1000-1) and the incubation buffer (Qdot™ 605, Cat. #1000-1) were obtained from Quantum Dot Corp. (Hayward, Calif.). Superparamagnetic, polystyrene microscopic beads covalently coated with affinity-purified polyclonal anti-E. coli O157 antibodies (Dynabeads anti-E. coli O157, diameter 2.8 μm, Cat. #710.04) were purchased from Dynal Biotech Inc. (Lake Success, N.Y.). Biotin conjugated anti-E. coli antibodies (Cat. #B65109B) were supplied by Biodesign International (Saco, Me.). Fluorescein isothiocyanate (FITC)-labeled affinity purified anti-E. coli O157:H7 antibodies (Cat. #02-95-90) were manufactured by Kirkegaard & Perry Laboratories (Gaithersburg, Md.). Phosphate buffered saline (PBS, 0.01 M, pH 7.4) and 1% (w/v) bovine serum albumin (BSA)-PBS (pH 7.4) were received from Sigma-Aldrich Chemical Co. (St. Louis, Mo.). Ultrapure water (18 MΩ cm) produced by a Millipore Milli-Q system (Molsheim, France) was used throughout.

Bacteria and Culture Plating Method. Escherichia coli O157:H7 (ATCC 43888), Escherichia coli K12 (ATCC 29425), and Salmonella typhimurium (ATCC 14028) were all obtained from ATCC (American Type Culture Collection, Rockville, Md.). The pure culture of E. coli O157:H7, E. coli K12 or S. typhimurium were grown in brain heart infusion (BHI) broth (Remel, Lenexa, Kans.) at 37° C. for 20 h before use. Cultures were serially diluted with physiological saline solution and the viable cell number was determined by conventional plate counting. Briefly, E. coli O157:H7 and E. coli K12 dilutions were surface plated on sorbitol-MacConkey (SMAC) agar (Remel, Lenexa, Kans.), the plates were incubated at 37° C. for 24 h, and the colonies were counted to determine the number of colony forming units per mL (CFU/mL). S. typhimurium was enumerated in the same way except using xylose lysine tergitol (XLT4) agar (Remel, Lenexa, Kans.). For safety, the undiluted cultures were heated in a 100° C. water bath for 15 min to kill all bacteria, and then diluted to the desired concentration with PBS for further use.

Procedure. The procedure was divided into two steps. First, the starting material (1.0 mL of sample solution containing ˜10⁷ CFU/mL of E. coli O157:H7) was contacted with 20 μL of magnetic beads coupled to an antibody specific to E. coli O157 and 100 μL of 500 μg/mL biotin conjugated anti-E. coli antibodies and vortexed on a VSM-3 mixer (Shelton Scientific Mfg., Shelton, Conn.) for several seconds. The mixtures were incubated at room temperature for 60 min with a gentle mixing on a RKVSD rotating mixer (Appropriate Technical Resources, Laurel, Md.) at 10 rpm. Then, the microcentrifuge tubes were loaded into MPC-S magnetic particle concentrators (Dynal Biotech) and allowed 3 min for separating the target comprised of immune complexes consisting of magnetic beads, the contaminant and biotin-conjugated anti-E. coli antibodies from the starting material. The unbound starting material was discarded and the target was rinsed with 1 mL of 1% BSA-PBS followed by magnetic separation three times.

The second step was QD-labeling followed by fluorescence measurement. A 300 μL aliquot of 10 nM QD-streptavidin conjugates were added to the target obtained from the first step. After vortexing, the mixtures were incubated at room temperature for 30 min with gentle rotation at 10 rpm, followed by magnetic separation. The streptavidin-conjugated QDs coupled to the target to form a labeled target. The resulting complexes were washed with 1 mL of PBS followed by magnetic separation three times. After the final wash step, the complexes were resuspended in 300 μL of PBS and transferred into 6-mm o.d.×50 mm long borosilicate glass round cuvettes (VWR, Cat. #47729-566) to measure the fluorescence emission spectra using an excitation wavelength of 473 nm. The blank (PBS) was subject to the same treatment as that of the samples.

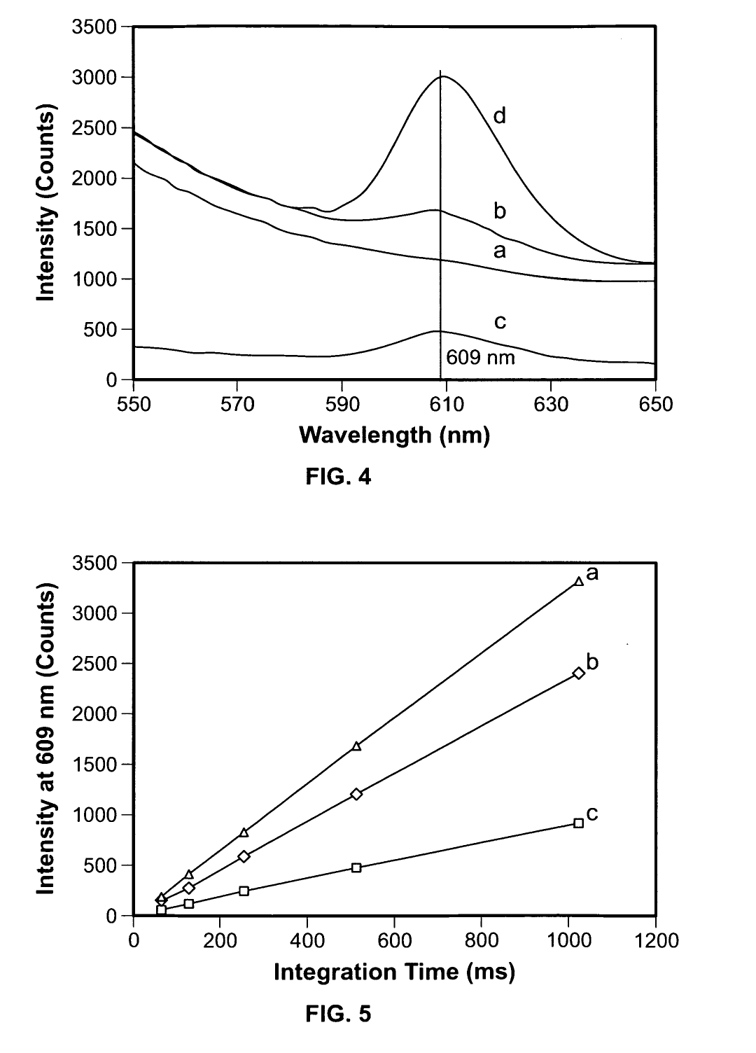

FIG. 4 shows typical fluorescence emission spectra. As can be seen, the blank (PBS), which was subject to the same treatment as the sample, gave no emission peak (curve a) while the sample (10⁷ CFU/mL E. coli O157:H7) had a maximum emission at 609 nm (curve b). To eliminate the influence of background reflection/backscattering, the blank spectrum was subtracted from the sample spectrum. The net spectrum of the sample also had a peak emission at 609 nm (curve c), which was identical with that of the QD solution alone (curve d). This indicates the successful attachment of the QDs to the target E. coli O157 cells. The excitation source used was a blue LED with a maximum emission at 473 nm; it excited the QD conjugates effectively and did not interfere with the fluorescence measurement. Another inherent benefit of blue light is that, unlike UV radiation which is commonly used as an excitation source for conventional fluorescent dyes, it does not kill cells and therefore the method is also suitable for the assay of live cells.

The setting of integration time is critical for the fluorescence measurement. As shown in FIG. 5, the intensities obtained at 609 nm for the sample (a), blank (b), and sample-blank (c) all increase linearly with integration times. To ensure a constant number of LED pulses during the integration time, the integration time was set to be powers of 2 as recommended by the manufacturer. An integration time of 1024 ms was chosen for further experiments to maximize the peak intensity while not saturating the CCD detector.

### EXAMPLE 2

### Fluorescence Intensity is Related to Contaminant Quantity

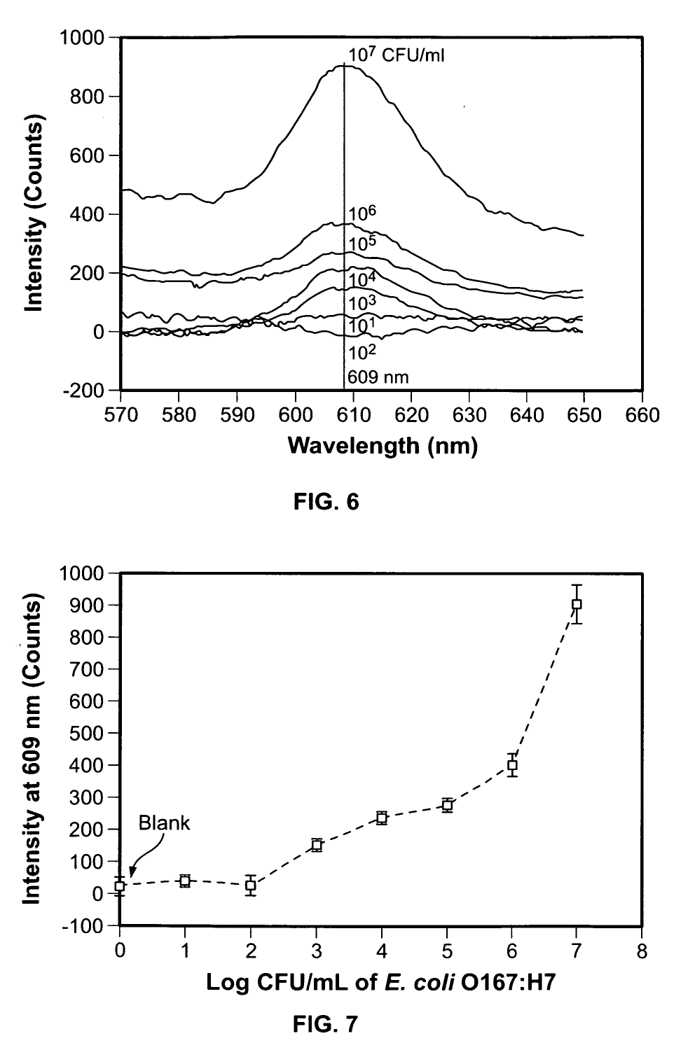

After subtracting the background signal of the blank, the intensities of fluorescence emission at 609 nm were correlated to the cell concentrations of E. coli O157:H7. Typical fluorescence spectra of 10¹-10⁷ CFU/mL E. coli O157:H7 are presented in FIG. 6 after subtracting the blank. As shown in this figure, the spectra of 10³-10⁷ CFU/mL all have a peak emission around 609 nm, but those of 10¹ and 10² CFU/mL do not have such a peak. The peak intensity at 609 nm as a function of the cell concentration is illustrated in FIG. 7. The intensity of the peak increases with increasing cell concentration in the range of 10³-10⁷ CFU/mL. However, the signals of the blank and the samples of 10¹ and 10² CFU/mL are not distinguishable. The limit to the level of detection may be due to the high background reflection/backscattering of the beads. The detection limit obtained in this work was ca. 10³ CFU/mL and the total detection time, from adding sample solution to obtaining the final result, was less than 2 h. No photo-bleaching was observed after the QD-labeled targets were exposed to room light for 24 h. The sample-to-sample reproducibility within the same batch was better than 10% RSD.

### EXAMPLE 3

### Comparison to Traditional Fluorophores

FITC-labeled anti-E. coli 0157 antibody solution containing ca. 170 nM FITC was tested for labeling the target for comparison to the QD detection method described above. Measured on the CCD spectrometer with the blue LED as excitation source, the FITC-labeled antibody solution showed a peak fluorescence emission at 521 nm, and the relative peak intensity of FITC to QD was 1:230. However, the FITC-labeled targets did not give any emission peaks and the sample signals could not be discriminated from the blank at a concentration of up to 10⁶ CFU/mL. A Fluoro-Tec fluorometer (St. John Associates, Beltsville, Md.) configured specifically for the FITC measurement was thus used for detecting the FITC-labeled targets. The fluorometer utilizes a 931 B photomultiplier tube (PMT) as detector, which is more sensitive but also more expensive than the CCD detector. Using the PMT-based fluorometer, the FITC-labeled targets were detectable at a sample concentration of ≧10⁵ CFU/mL. Hence, the QD labeling method of the present invention is at least 100 times more sensitive than the FITC labeling method in detecting E. coli O157:H7.

The sensitivity of the present method may be further improved by optimizing the concentrations of magnetic beads, biotin-conjugated antibodies and QDs as well as the incubation time to enhance the signal-to-background ratios at lower cell concentrations (<10³ CFU/mL). The amount of magnetic beads recommended by the manufacturer is 20 μL (ca. 0.1 mg or 6.7×10⁶ beads) per mL of pre-enriched sample along with a 30 min-incubation. Since the step of sample pre-enrichment was omitted, a longer incubation time (60 min) was taken while the recommended amount of magnetic beads was used. At low cell concentrations, the amount of magnetic beads was in excess and therefore the magnetic beads could capture almost all target bacteria. However, an excess of magnetic beads might decrease the sensitivity of final fluorescence detection. In the present method, appropriately high concentrations of magnetic beads, biotin-conjugated antibodies (both compared to the level of target cells) and QDs (compared to the level of biotin-conjugated antibodies) would be necessary for highly sensitive detection, but overly high concentrations may decrease the signal-to-noise ratio.

### EXAMPLE 4

### Specificity of the Method

The specificity is mainly dependent upon the capture antibodies, i.e., the antibodies immobilized on the magnetic bead surface. E. coli O157:H7 bacteria contain specific O polysaccharide (O157) and flagellar protein (H7) antigens. Therefore, the combination of monoclonal antibodies against unique epitopes on the O157 and H7 antigens is a logical approach for specific detection of E. coli O157:H7, minimizing interferences from other bacteria including non-O157 and non-H7 serotypes of E. coli. However, these monoclonal antibodies are not commercially available, but polyclonal anti-E. coli O157 antibodies may also serve well as capture antibodies as the cross-reactivity to other E. coli strains can be minimized through affinity purification. Commercially available magnetic beads were coated with affinity-purified anti-E. coli O157 antibodies. Since the specific capture antibodies had already selected the bacteria, biotin conjugated generic anti-E. coli antibodies were used as the affinity moiety for QD-labeling. All other bacteria with which the secondary antibodies could cross-react would not have been bound by the capture antibodies and would have been washed out during magnetic separation.

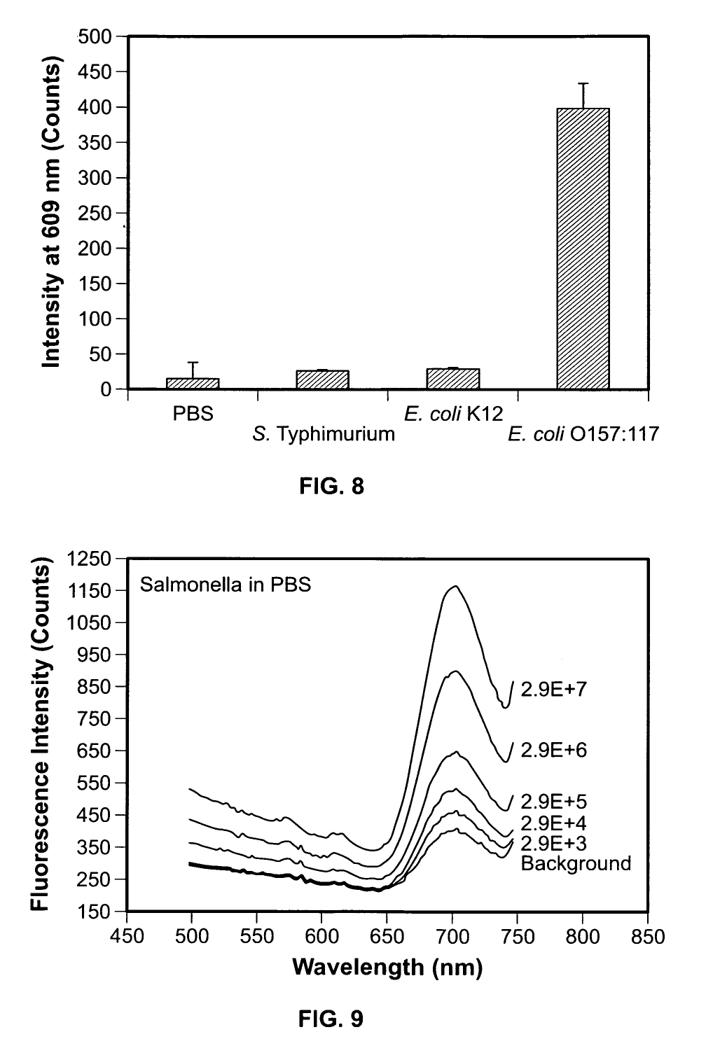

For evaluating the specificity, generic E. coli (serotype K12) and S. typhimurium, one of the most common foodborne pathogens, were tested as potential competing bacteria of E. coli O157:H7. As shown in FIG. 8, at a concentration of 10⁶ CFU/mL, neither E. coli K12 nor S. typhimurium interfered with the detection of E. coli O157:H7.

Therefore, this invention provides a sensitive, specific and rapid method for detection of E. coli O157:H7 based on the combination of QD-biolabeling with magnetic separation. The method could detect 10³-10⁷ CFU/mL of E. coli O157:H7 in 2 h, with a detection limit comparable to conventional immunomagnetic separation-immunoassay and flow cytometry and at least 100 times lower than the FITC method. No significant interference was observed from E. coli K12 or S. typhimurium.

### EXAMPLE 5

### Detection of Salmonella typhimurium with QD Biolabeling Coupled with Magnetic Separation

Reagents. Biotinylated rabbit anti-Salmonella antibody (4-5 mg/mL) was obtained from Biodesign International (Saco, Me.). A 1:10 dilution of anti-Salmonella antibody was prepared with PBS, pH 7.4 for further use. Magnetic beads coated with rabbit anti-Salmonella antibody were from Dynal, Inc. (Lake Success, N.Y.). Qdot® 705 streptavidin conjugate (2 μM) was purchased from Quantum Dot Corporation (Hayward, Calif.). Stock cultures of Salmonella typhimurium (ATCC 14028) and Escherichia coli O157:H7 (ATCC 43888) were obtained from American Type Culture Collection (Manassas, Va.). Listeria monocytogenes (FDA, 101M 4B) was from the Food and Drug Administration (FDA).

Assay procedure. Salmonella cells were initially captured by magnetic beads coated with rabbit anti-Salmonella antibody and separated from the sample matrix. In this step, 20 μL of immunomagnetic beads were added to 1 mL of Salmonella containing sample. The mixture was shaken on a RKVSD 10101 mixer (ART, Inc., Laurel, Md.) at a speed of 10 rpm for 1 h at room temperature. The bead-cell targets were separated from the starting material by putting the tube on a magnetic separator for 2 min. The unbound material was removed using a syringe. The targets were resupended with 0.3 mL PBS (pH 7.4) after they were washed with 0.5 mL PBS (pH 7.4). Second, biotinylated anti-Salmonella antibodies were used as the second affinity moiety and were linked to the above targets to form biotinylated targets. To perform this step, 30 μL of 0.4-0.5 mg/mL biotinylated anti-Salmonella antibody in PBS was added to the target. After 1 h reaction, biotinylated targets were separated from the solution by magnetic separation. Unbound material was removed using a syringe. The biotinylated targets were washed with 0.5 mL PBS (pH 7.4) twice. Finally, 200 μL of 10 nM streptavidin coated QDs 705 was added to the biotinylated targets and incubated at room temperature for 30 min. QDs 705 attached to the bacterial cell through the reaction between strepavidin on the QDs and biotin on the antibodies. After removing the excess QDs solution, the QD-labeled targets were washed with PBS, pH 7.4, twice and resuspended with 150 μL PBS, pH 7.4. The fluorescence intensity produced by these QDs was measured using a spectrometer.

FIG. 9 shows the results of one experiment to enumerate S. typhimurium in pure culture. The background gave a fluorescent peak at 705 nm with an intensity of 166 counts. In contrast, a sample containing 2.9×10³ CFU/mL Salmonella cells produced a fluorescent peak with an intensity of 224 counts, which is significantly different from the background signal. The fluorescence intensity increased with increasing numbers of Salmonella from at least 2.9×10³ to 2.9×10₇ CFU/mL. This result demonstrated that fluorescence intensity was proportional to the number of cells in the sample.

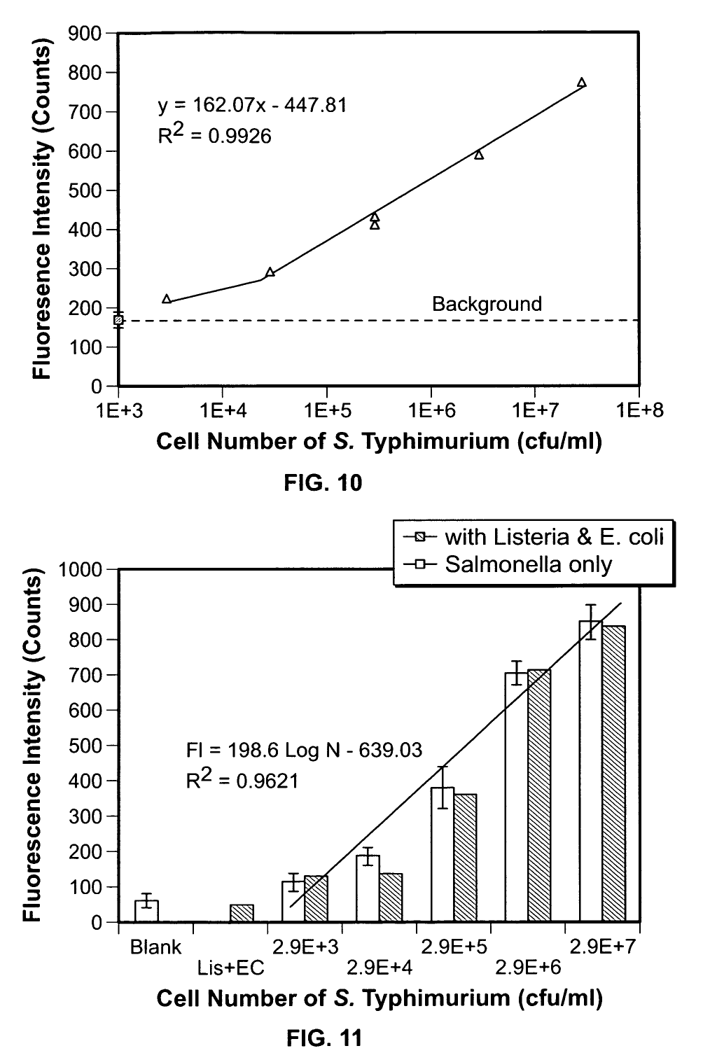

FIG. 10 demonstrates a linear relationship between S. typhimurium cell number (N) in the samples and the fluorescence intensity (FI) exists for cell concentrations ranging from 10₄ to 10₇ CFU/mL. The regression model can be expressed as: FI=166.07 log N−447.81 with R=0.99. Three measurements of the background signal gave an average at 163 counts with a standard deviation of 8 counts. When the background signal plus three times of its standard deviation was taken as the threshold of the signal, the detection limit of this method was 10³ CFU/mL.

### EXAMPLE 6

### Detection of Salmonella in Chicken Carcass Wash Water

Chicken carcass wash water samples. Twenty-four chicken carcasses were obtained from a poultry processing plant. Each carcass was put into a Whirl-pak plastic bag (Nasco, Fort-Atkinson, Wis.) containing 100 mL of 0.1% buffered peptone water (Difco, Kansas City, Mo.) and mechanically shaken for 2 min. Carcass wash water from each bird was mixed together for the experiment. The carcass wash water was inoculated with S. typhimurium at different concentrations to make serial samples with the same volume of 5 mL. Each sample was filtered using a syringe filter (Pore size 5 μm, MSI, Westboro, Mass.) to remove solid components. Then 1 mL of the filtered solution was centrifuged by VSMC-13 mini-centrifuge (Shelton Scientific, Shelton, Conn.) at 10,000×g for 15 min to separate Salmonella cells from other components, such as protein, plasma, etc. After removing the supernatant, 1 mL of PBS, pH 7.4, was added to the tube to resuspend Salmonella cells.

FIG. 11 shows the relationship between the fluorescence intensity and S. typhimurium cell numbers in the samples of chicken carcass wash water with and without the presence of L. monocytogenes and E. coli O157:H7. For the samples containing Salmonella only, the fluorescence intensity increased with increasing Salmonella cell number in the range from 2.9×10³ to 2.9×10⁷ CFU/mL. The regression model can be expressed as: FI=198.6 Log N−639.03 with R²=0.96. This trend is similar to that of Salmonella in PBS solution reported in Example 5. The blank sample containing no Salmonella produced an average signal of 63 counts with a standard deviation of 18, which was lower than the background signal of the blank sample in PBS (163 counts). This decrease in the background signal may be due to the presence of proteins in chicken carcass wash water that reduce non-specific binding interactions. The sample containing 2.3×10⁴ CFU/mL of L. monocytogenes and 3.5×10³ CFU/mL of E. coli O157:H7 produced a fluorescent signal of 45 counts, which was close to the background signal of 63 counts, indicating the presence of these non-target bacteria did not increase nonspecific binding. Samples containing the same numbers of L. monocytogenes and E. coli O157:H7 but with increasing numbers of S. typhimurium presented increasing fluorescence signals indicating the presence of non-target contaminants did not interfere with the function of the assay. In addition, samples with and without L. monocytogenes and E. coli O157:H7 produced similar fluorescence intensities, indicating that non-target bacteria did not interfere with the sensitivity or linearity of detection of S. typhimurium in chicken carcass wash water.

### EXAMPLE 7

### Method for the Simultaneous Detection of E. coli and Salmonella typhimurium

Reagents. Biotinylated rabbit anti-Salmonella antibody (4-5 mg/mL) and anti-E. coli O157 antibody (4-5 mg/mL) were obtained from Biodesign International (Saco, Me.). According to the product manual from the company, the biotinylated anti-E. coli antibody is highly specific for E. coli O157:H7. Cross-reactivity to other E. coli strains has been minimized through extensive adsorption using non-O157:H7 serotypes of E. coli. The biotinylated anti-Salmonella antibody may show some cross-reactivity to related Enterobacteriaceae. Dilutions of anti-Salmonella antibody were prepared with PBS, pH 7.4 for further use. Magnetic beads (MB) coated with rabbit anti-Salmonella antibody and MB coated with anti-E. coli antibody were from Dynal, Inc. (Lake Success N.Y.). Qdot® 525 streptavidin conjugate (2 mM) were purchased from Quantum Dot Corporation (Hayward, Calif.). Dilutions of QDs were made with the buffer supplied with the QDs.

QD-antibody conjugation. QD-antibody conjugates were developed using the coupling strategy between streptavidin and biotin. The coupling reaction is shown in FIG. 3. In detail, 10 μL of biotinylated anti-Salmonella antibody (1:10 dilution) and 10 μL of biotinylated anti-E. coli antibody (1:10 dilution) were added to 100 μL of 0.2 μM of QDs 705 and 100 μL of 0.2 μM QDs 525, respectively. After a 30 min incubation at room temperature, QD705-anti-Salmonella antibody conjugates and QD525-anti-E. coli antibody conjugates were formed and ready for further use. All QD-antibody conjugates were made up fresh everyday for tests.

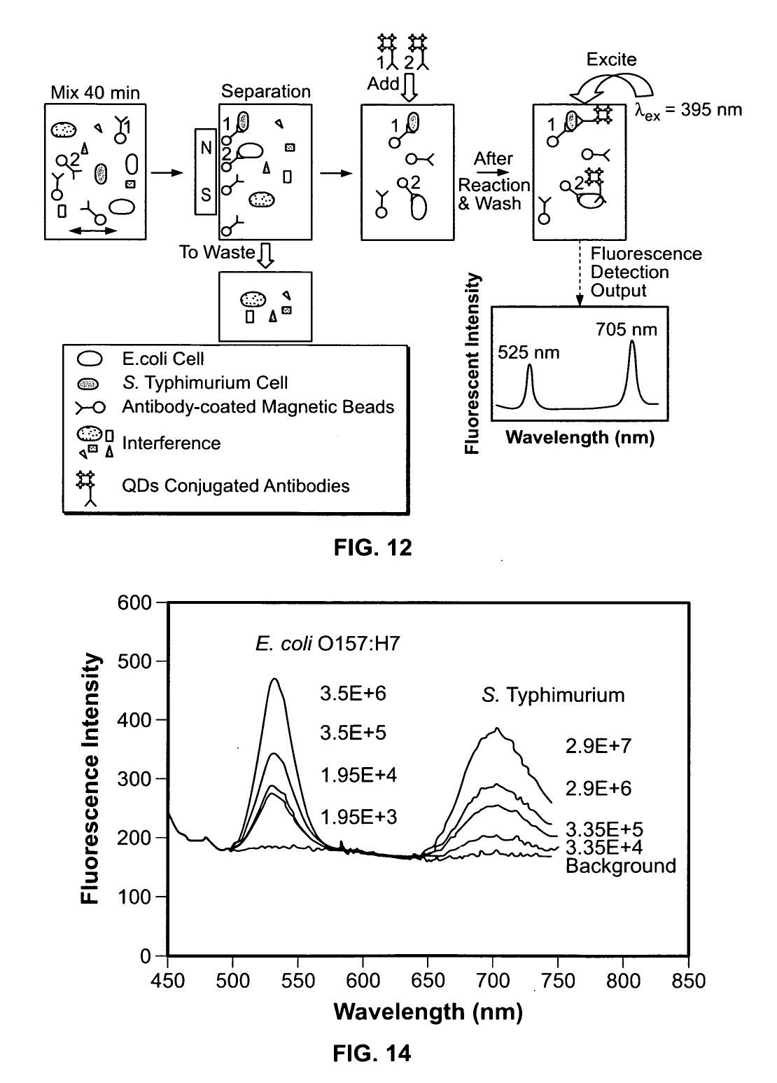

Immunoassy procedure. The entire immunoassay procedure for detection of the two species of bacteria is outlined in FIG. 12. First, S. typhimurium cells and E. coli O157:H7 cells were captured by magnetic beads coated with antibodies that are selective for each species of the bacterial cells and separated from the sample matrix. In this step, 20 μL of each type of immunomagnetic beads were added to 1 mL of the sample containing the two species of bacterial cells. The mixture was shaken on a RKVSD 10101 mixer (ART, Inc., Laurel, Md.) at a speed of 10 rpm for 40 min at room temperature. The bead-cell complexes were then separated from the solution by putting the tube on a magnetic separator for 2 min. After removing the liquid, the bead-cell complexes were washed with 0.5 mL PBS (pH 7.4). The QD-antibody conjugates were added to the above bead-cell complexes to form bead-cell-QD labeled conjugates. To perform this step, 50 μL of each type of QD-antibody conjugate was added to the bead-cell complexes. After 30 min reaction, the labeled conjugates were separated from the solution using the magnetic separator. The labeled conjugates were washed with 0.5 mL PBS (pH 7.4) twice, and resuspended with 150 μL PBS, pH 7.4. The fluorescence intensity produced by these QDs attached to bacterial cells was measured using a spectrometer.

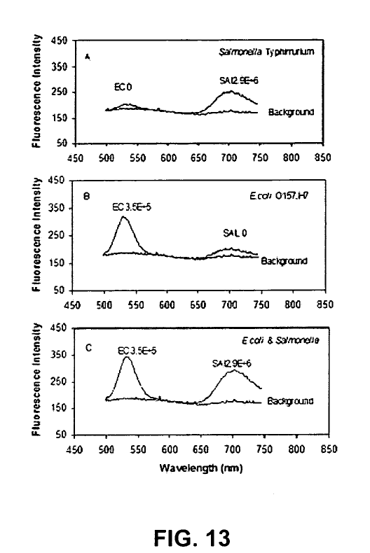

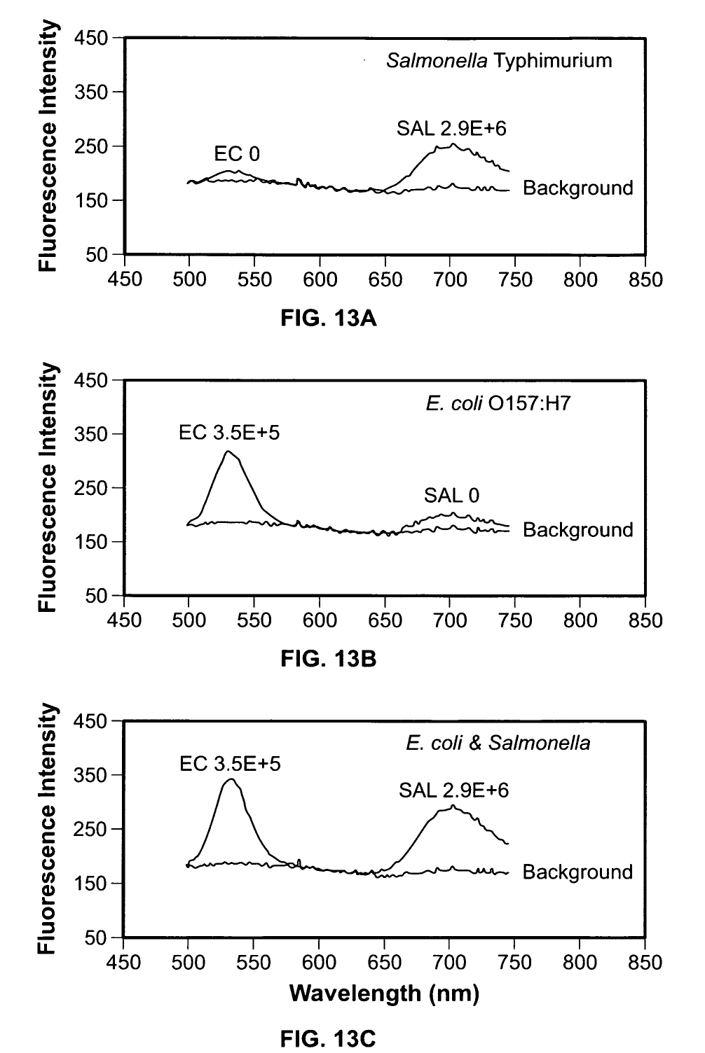

Fluorescence spectra of single species of bacteria and mixed bacteria. FIG. 13 represents fluorescence spectra obtained from the samples containing no bacteria (background), (A) Salmonella typhimurium only, (B) E. coli O157:H7 only, and (C) the mixture of the two species. The background fluorescence spectrum was obtained from the sample that contained 20 μL anti-E. coli antibody coated magnetic beads, 20 μL anti-Salmonella antibody coated magnetic beads, and PBS. As shown in FIG. 13, no evident fluorescence peaks at 525 nm and at 705 nm were observed in the background spectrum. This result indicated that there was no evident non-specific binding between magnetic beads and QD-antibody conjugates without the presence of bacterial cells.

FIG. 13A shows the spectrum produced by the sample containing 2.9×10⁶ CFU/mL of S. typhimurium. It shows a well shaped fluorescence peak at 705 nm with a net peak intensity of 70 counts (255-210 counts). The fluorescence peak at 705 nm was produced by QDs 705 that were attached to Salmonella cells through the reaction between QD705-anti-Salmonella antibody conjugates and Salmonella cells. At the same time, a small peak at 525 nm was observed on this fluorescence spectrum. This small fluorescence peak was due to the non-specific binding between the Salmonella cells and the QD525-anti-E. coli antibody conjugates. The net intensity of this peak was approximately 17 counts (201-185 counts), which was much lower than that of the peak at 705 nm. Similar results were observed for the sample containing 3.5×10⁵ CFU/mL E. coli O157:H7 as shown in FIG. 13B. The fluorescence spectrum shows a strong peak at 525 mm and a small peak at 705 nm. The peak at 525 nm was produced by QDs 525 which was introduced to E. coli cells through the specific reaction between the E. coli cells and QD525-anti-E. coli antibody conjugates, while the peak at 705 nm was produced by QDs 705 which bound to E. coli cells via non-specific binding between E. coli cells and QD705-anti-Salmonella antibody conjugates.

FIG. 13C shows the fluorescence spectrum obtained from the sample containing both E. coli O157:H7 and S. typhimurium. As seen on the spectrum, two strong peaks at 525 nm and 705 nm represent the fluorescence signals produced by E. coli O157:H7 cells and S. typhimurium cells, respectively. This result indicated that each type of QD-antibody conjugate could bind to their target bacteria in the mixture of the two species and produce fluorescence signals.

Comparison of FIG. 13C with FIGS. 13A and B shows that the intensity of the fluorescence peak at 525 nm of the mixture sample (FIG. 13C, 339 counts) is higher than that of the peak at 525 nm of the single species sample (FIG. 13B, 317 counts). Similarly, the emission peak at 705 nm in FIG. 13C (294 counts) is higher than the peak at 705 nm in FIG. 13A (255 counts). This comparison indicated that the sample of mixed bacteria produced higher fluorescence peaks than those samples with single species of bacteria even when the concentrations of the target bacteria are the same. The most likely reason for the elevated emission peaks at 525 nm and 705 nm for the mixed sample are cross reactions between QD525-anti-E. coli antibody and Salmonella cells and between QD705-anti-Salmonella antibody and E. coli cells. This is experimentally consistent with the small peaks seen in the single bacteria samples (FIGS. 13A and B) that were due to nonspecific binding. Cross reactions might also occur between bacterial cells and antibodies on the magnetic beads. In spite of the low level non-specific binding, these results indicate this method provides a way to simultaneously assay for the presence of two species of target bacteria.

### Simultaneous Detection of E. coli O157:H7 and Salmonella typhimurium

FIG. 14 shows a representative group of fluorescence spectra obtained from the samples containing a mixture of different bacterial cell numbers of E. coli 0175:H7 and S. typhimurium. It can be seen that the intensity of the fluorescence peak at 705 mm increased with the increasing cell number of S. typhimurium in the range of 3.35×10⁴ to 2.9×10⁷ CFU/mL in the mixture of the two bacteria samples, demonstrating that the more Salmonella cells in the sample, the more QDs they could bind, and thus the stronger fluorescence they could produce. The sample containing the mixture of 3.35×10⁴ CFU/mL Salmonella and 1.95×10³ CFU/mL E. coli has an emission peak at 705 nm with a net peak intensity of 23 counts. However, this emission peak is indistinguishable from the non-specific peak (˜20 counts) produced by 3.5×10⁵ CFU/mL of E. coli at 705 mm (as shown in FIG. 13B).

Similarly, as shown in FIG. 14, when E. coli cell number increased from 1.95×10³ cfu/mL to 3.5×10⁶ CFU/mL, the intensity of the fluorescence peak at 525 nm increased from 271 counts to 462 counts, implying that the higher the concentration of E. coli cells in the mixture, the stronger fluorescence signal they could generate. The sample containing 1.95×10³ CFU/mL of E. coli O157:H7 in the mixture presents a well-shaped peak at 525 nm with the peak intensity of 85 counts, while the background spectrum did not show a shaped peak at 525 nm. The signal produced by 1.95×10³ CFU/mL of E. coli O157:H7 in the mixture is also much higher than that produced by the non-specific peak of 2.9×10⁶ CFU/mL S. typhimurium at 525 nm (17 counts, as seen in FIG. 13A). This result indicated that 1.95×10³ CFU/mL of E. coli O157:H7 could result in a detectable signal in the presence of 1000 times higher concentration of S. typhimurium in a mixture of the two bacteria samples.

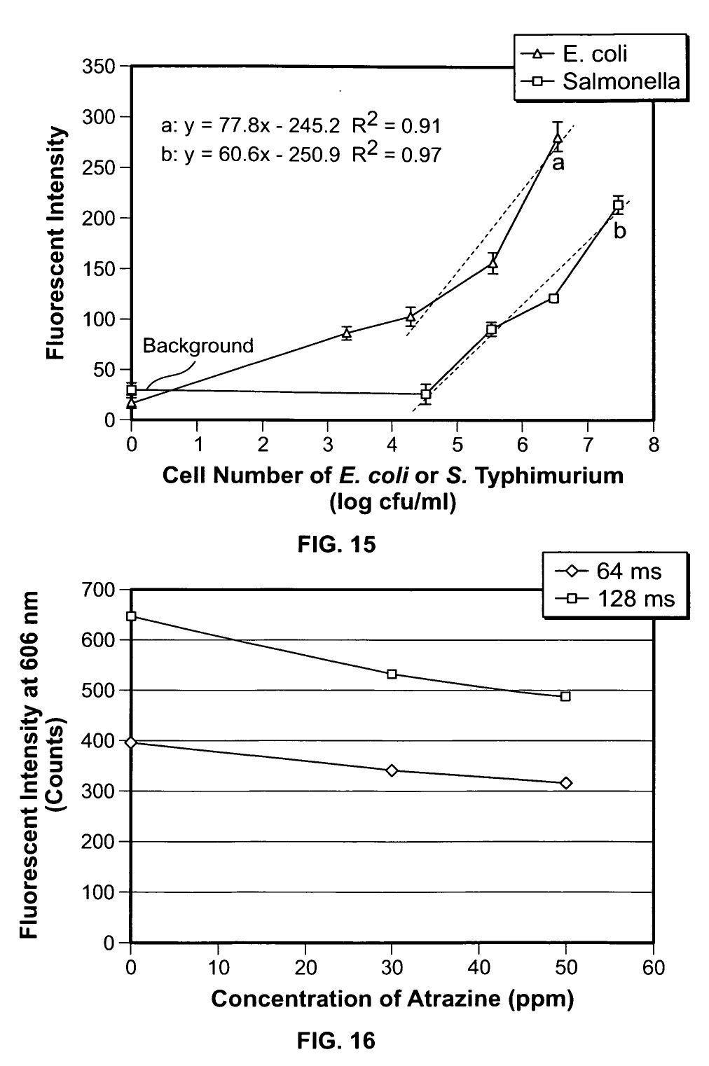

The fluorescence intensity (FI) at 525 nm and 705 mm as functions of cell numbers (N) of E. coli and Salmonella in the mixed bacterial sample are presented in FIG. 15. The regression models can be expressed as: FI−60.6 log N−250.9 with R²=0.97 for S. typhimurium in the cell number ranging from 10⁴ to 10⁷ CFU/mL, and FI=77.8 log N−245.2 with R²=0.91 for E. coli O157:H7 in the range of cell numbers from 10⁴ to 10⁷ CFU/mL. These results indicated that it is possible to determine bacterial cell numbers of E. coli O157:H7 and S. typhimurium simultaneously based on the measurement of the intensities of the fluorescence peaks at 525 nm and 705 nm, respectively. The non-specific signals are 17±4.58 at 525 nm and 28±7.5 at 705 nm. The detection limits of this method for E. coli O157:H7 and S. typhimurium were ca. 10⁴ CFU/mL by setting the signal level higher than the nonspecific signal. The detection could be completed within 2 hours.

### EXAMPLE 8

### Competitive Labeling Method for the detection of Atrazine

Reagents. Monoclonal antibody to atrazine (2-chloro-4-(ethylamine)-6-(isopropylamine)-s-triazine) and BSA-atrazine were obtained from Biodesign International (Saco, Me.). Atrazine (Pestanol®) was purchased from Sigma-Aldrich Laborchemikalien (Seelze, Germany). Streptavidin conjugated nanoparticles (Captivate™ ferrofluid streptavidin) were obtained from Molecular Probes, Inc. (Eugene, Oreg.). Quantum dots were supplied by the Quantum Dot Corp. (Hayward, Calif.) and the Qdot Antibody Conjugation kit was used to couple the antibody to the quantum dot.

Preparation of the competitor nanoparticle coupled to atrazine. The BSA-atrazine was coupled to streptavidin coated nanoparticles by slow addition of glutaraldehyde (0.25%) for 1 hour with constant mixing resulting in cross-linking of BSA-atrazine to the nanoparticles. The nanoparticles were separated from unbound BSA-atrazine by magnetic separation followed by three washes to remove any unbound BSA-atrazine.

Competitive binding assay procedure. The starting material, containing known dilutions of atrazine, and control material, containing no atrazine, were mixed with 10 μL of 1.2 μM QD conjugated to the monoclonal antibody and 50 μL of nanoparticles bound to BSA-atrazine (competitor complex). The combination was mixed for 30 minutes with gentle rotation at 10 rpm at room temperature. The combination was then subjected to a magnetic field to separate the competitor complexes bound to the antibody-QD from the starting or control material. The competitor complexes were washed three times with PBS to remove any unbound antibody-QD complexes. If atrazine was present in the starting material, this atrazine would compete with the competitor complex for binding the antibody-QD and would be expected to reduce the amount of QD-antibody binding to the competitor complex and thus reduce the fluorescence intensity associated with the competitor complex. Finally, the competitor complexes were resuspended in 200 μL PBS and the fluorescence emission of the competitor complex was detected at 606.5 nm using an Ocean Optics USB 2000 fluorescence detector at a selected integration time of either 64 ms or 128 ms.

The results of this experiment are shown in Table 1 and FIG. 16. Table 1 contains the fluorescence intensity data from a representative experiment comparing a control sample that contained no atrazine to samples containing atrazine at 30 ppm or 50 ppm and FIG. 16 is a graphic representation of the same data. The experiment demonstrated that the antibody-QD complex was capable of binding the competitor complex when no atrazine was present in the control material as shown by the relatively high level of fluorescence intensity.

TABLE 1
Results of the test on detection of atrazine residue using the biosensing
method based on quantum dot biolabels and magnetic nanoparticle
immunoseparation

Fluorescent Intensity at 606 nm
(counts)

| Concentration of | Integrated Time | Integrated Time |
|---|---|---|
| Atrazine (ppm) | 64 ms | 128 ms |
| 0 | 394.7 | 645.7 |
| 30 | 342.6 | 531.8 |
| 50 | 314.3 | 486.1 |

When atrazine was present in the starting material, the fluorescence intensity associated with the quantum dot-competitor complex was reduced. For example, when 50 ppm atrazine was present in the starting material the fluorescence intensity of the quantum dot-competitor complex was reduced to 486 counts with a 128 ms integration time from 646 counts when no atrazine was added. This competitive binding assay can be used to detect the presence of atrazine at very low concentrations (30 ppm) in a starting material.

In addition, as demonstrated in FIG. 16, the fluorescence intensity of the quantum dot-competitor complex was inversely related to the concentration of atrazine in the starting material. When the starting material contained 30 ppm atrazine, the fluorescence intensity of the quantum dot-competitor complex was higher (closer to the intensity of the control containing no atrazine) than when the starting material contained 50 ppm atrazine. This dose responsiveness indicates that the competitive assay described herein could be used to quantify the amount of a contaminant in a starting material, by comparing an experimental sample containing an unknown quantity of the contaminant, atrazine in this example, to a dose curve obtained from adding known quantities of the contaminant to the experiment.

Various features of the invention are set forth in the following claims.

We claim:

1. A method of detecting a contaminant in a starting material, comprising:
a) immunomagnetically separating the contaminant,
b) quantum dot-immunolabeling the contaminant, and
c) detecting and analyzing a characteristic emission spectrum of the quantum dot.

2. The method of claim 1, wherein step (a) comprises contacting the starting material with a magnetic bead coupled to a first antibody capable of binding the contaminant to form a bead-antibody-contaminant complex, and magnetically separating the complex from the starting material.

3. The method of claim 1, wherein step (b) comprises contacting the contaminant with a quantum dot coupled to a second antibody capable of binding the contaminant to form a quantum dot-antibody-contaminant complex.

4. The method of claim 1, wherein step (b) comprises quantum dot labeling the complex of step (a).

5. The method of claim 1, wherein step (a) and step (b) can be carried out simultaneously.

6. The method of claim 1, wherein step (b) can precede step (a).

7. The method of claim 1, wherein the starting material is selected from the group consisting of a food product, an environmental sample and a clinical sample.

8. The method of claim 1, wherein the contaminant is selected from the group consisting of a prokaryote, a eukaryote, a virus, and a polypeptide.

9. A method of detecting a contaminant in a starting material, the method comprising:
a) contacting the starting material with a bead coupled to a first affinity moiety capable of binding the contaminant to form a target, the target comprising the bead coupled to the contaminant;
b) separating the target from the starting material;
c) contacting the target with a quantum dot coupled to a second affinity moiety capable of binding the contaminant of the target of step (a) to form a labeled target, the labeled target comprising the target coupled to the quantum dot, the quantum dot having a characteristic emission spectrum; and
d) detecting the characteristic emission spectrum of the quantum dot in the labeled target of step (c), wherein the presence of the characteristic emission spectrum is indicative of the detection of the contaminant.

10. The method of claim 9, wherein more than one contaminant is simultaneously detected by a plurality of quantum dots, each of the plurality having a distinct characteristic emission spectrum and coupled to a distinct affinity moiety capable of binding a distinct contaminant to form more than one labeled target.

11. The method of claim 9, wherein the starting material is selected from the group consisting of a food product, an environmental sample and a clinical sample.

12. The method of claim 11, wherein the food is selected from the group consisting of a fruit, a vegetable, a raw food, a ready-to-eat food, a beef product, a poultry product, a sea food product, and a dairy product.

13. The method of claim 12, wherein the poultry product is selected from the group consisting of a chicken carcass, a chicken carcass wash water, a deboned chicken, a ground poultry meat sample, and a poultry patty.

14. The method of claim 11, wherein the environmental sample is selected from the group consisting of a water sample, an air sample and a soil sample.

15. The method of claim 11, wherein the clinical sample is selected from the group consisting of a urine sample, a blood sample, a fecal sample, a swab from a skin surface, a swab from an organ surface and a tissue sample.

16. The method of claim 9, wherein the contaminant is selected from the group consisting of a prokaryote, a eukaryote, a virus, and a polypeptide.

17. The method of claim 16, wherein the prokaryote is Escherichia coli, Escherichia coli O157:H7, Salmonella spp., and Listeria monocytogenes.

18. The method of claim 16, wherein the polypeptide is selected from the group consisting of a toxin and a prion.

19. The method of claim 9, wherein the bead is selected from the group consisting of a microbead, a magnetic microbead, a nanoparticle and a magnetic nanoparticle.

20. The method of claim 9, wherein the target is separated from the starting material by subjecting the starting material to a magnetic field.

21. The method of claim 9, wherein the first affinity moiety and the second affinity moiety comprise an antibody having affinity for the contaminant.

22. The method of claim 21, wherein the antibody is coupled directly to the quantum dot and to the bead.

23. The method of claim 21, wherein the antibody is coupled to the quantum dot and to the bead by a linker.

24. The method of claim 23, wherein the linker is selected from the group consisting of Protein A, Protein G, an Fc receptor, and an anti-Fc antibody.

25. The method of claim 23, wherein the linker comprises a bridging complex selected from the group consisting of: biotin-streptavidin, biotin-avidin, Protein A-IgG, Protein G-IgG, and IgG-anti-IgG.

26. The method of claim 9, wherein the characteristic emission spectrum of the quantum dot is detected by fluorescence microscopy.

27. The method of claim 9, wherein the characteristic emission spectrum of the quantum dot is detected by spectroscopy.

28. The method of claim 9, wherein the target is separated from the starting material by centrifugation.

29. The method of claim 9, wherein the target is separated from the starting material by filtration.

30. The method of claim 9, wherein the first affinity moiety and the second affinity moiety are the same or different.

31. The method of claim 9, further comprising:
e) isolating the contaminant from the labeled target.

32. The method of claim 9, further comprising:
e) subjecting the labeled target and the separated contaminant to antibiotic resistance testing.

33. The method of claim 9, further comprising:
e) subjecting the labeled target to microbiologic, immunologic, or nucleic acid based assays.

34. A method of quantifying contaminants in a starting material, the method comprising:
a) contacting the starting material with a bead coupled to a first affinity moiety capable of binding the contaminant to form a target, the target comprising the bead coupled to the contaminant;
b) separating the target from the starting material;
c) contacting the target with a quantum dot coupled to a second affinity moiety capable of binding to the contaminant to form a labeled target, the labeled target comprising the target coupled to the quantum dot, the quantum dot having a characteristic emission spectrum;
d) detecting the intensity of the characteristic emission spectrum of the quantum dot in the labeled target of step (c); and
e) determining the quantity of the contaminant in the starting material by correlating the emission spectrum intensity of step (d) with the emission spectrum intensity of a labeled target containing a known number of contaminants.

35. The method of claim 34, wherein the starting material is selected from the group consisting of a food product, an environmental sample and a clinical sample.

36. The method of claim 34, wherein the contaminant is selected from the group consisting of a prokaryote, a eukaryote, a virus, and a polypeptide.

37. The method of claim 34, wherein the bead is selected from the group consisting of a microbead, a magnetic microbead, a nanoparticle and a magnetic nanoparticle.

38. The method of claim 34, wherein the target is separated from the starting material by subjecting the starting material to a magnetic field.

39. A method of separating a contaminant from a starting material, the method comprising:
a) contacting the starting material with a composition comprising a magnetic bead coupled to a first affinity moiety capable of binding the contaminant to form a target, the target comprising the magnetic bead coupled to the contaminant;
b) contacting the target with a quantum dot coupled to a second affinity moiety capable of binding the contaminant of the target of step (a) to form a labeled target, the labeled target comprising the target coupled to the quantum dot, the quantum dot having a characteristic emission spectrum;
c) separating the labeled target from the starting material; and
d) detecting the characteristic emission spectrum of the quantum dot in the labeled target of step (c), wherein the presence of the characteristic emission spectrum is indicative of the detection of the contaminant.

40. A kit for detecting a contaminant in a starting material, the kit comprising:
a) a bead capable of being coupled to a first affinity moiety;
b) the first affinity moiety capable of binding the contaminant;
c) a quantum dot capable of being coupled to a second affinity moiety, the quantum dot having a characteristic emission spectrum; and
d) the second affinity moiety capable of binding to the contaminant.

41. The kit of claim 40, wherein the first affinity moiety and the second affinity moiety comprise at least one antibody.

42. The kit of claim 41, wherein the at least one antibody is coupled to the quantum dot and to the bead by a linker.

43. The method of claim 42, wherein the linker is selected from the group consisting of Protein A, Protein G, an Fc receptor, and an anti-Fc antibody.

44. The method of claim 42, wherein the linker comprises a bridging complex selected from the group consisting of: biotin-streptavidin, biotin-avidin, Protein A-IgG, Protein G-IgG, and IgG-anti-IgG.

45. The method of claim 40, wherein the bead is selected from the group consisting of a microbead, a magnetic microbead, a nanoparticle and a magnetic nanoparticle.

46. The kit of claim 40, further comprising:
e) a solution comprising a known concentration of the contaminant.

47. A method of detecting a contaminant in a starting material, the method comprising:
a) contacting the starting material containing a contaminant and a control material not containing the contaminant each with 1) a quantum dot coupled to an affinity moiety, the affinity moiety capable of binding the contaminant and 2) a competitor complex comprising a bead coupled to the contaminant;
b) separating the competitor complex from each of the starting material and the control material; and
c) detecting the characteristic emission spectrum of the quantum dot associated with the competitor complex from each of the starting material and the control material, wherein a decrease in the intensity of the characteristic emission spectrum of the competitor complex from the starting material as compared to the intensity of the characteristic emission spectrum of the competitor complex from the control material is indicative of the presence of the contaminant in the starting material.

48. The method of claim 47, wherein the starting material is selected from the group consisting of a food product, an environmental sample and a clinical sample.

49. The method of claim 47, wherein the contaminant is selected from the group consisting of a prokaryote, a eukaryote, a virus, a polypeptide and a chemical.

50. The method of claim 49, wherein the chemical is selected from the group consisting of a herbicide and a pesticide.

51. The method of claim 50, wherein the herbicide comprises 2-chloro-4-(ethylamine)-6-(isopropylamine)-s-triazine.

52. The method of claim 47, wherein the bead is selected from the group consisting of a microbead, a magnetic microbead, a nanoparticle and a magnetic nanoparticle.

53. The method of claim 47, wherein the target is separated from the starting material by subjecting the starting material to a magnetic field.

54. A method for quantifying a contaminant in a starting material, the method comprising:
a) contacting the starting material containing the contaminant, a control material not containing the contaminant and at least one control material containing a known amount of the contaminant each with 1) a quantum dot coupled to an affinity moiety capable of binding the contaminant and 2) a competitor complex comprising a bead coupled to the contaminant;
b) separating the competitor complex from each of the starting material, the control material not containing the contaminant and at least one control material containing a known amount of the contaminant;
c) detecting the characteristic emission spectrum of the quantum dot associated with the competitor complex from each of the starting material, the control material not containing the contaminant and at least one control material containing a known amount of the contaminant; and
d) comparing the intensity of the characteristic emission spectrum of the quantum dot-competitor complex from the starting material to the intensity of the characteristic emission spectrum of the quantum dot-competitor complex from the control material containing a known amount of the contaminant, wherein the intensity of the characteristic emission spectrum is indicative of the quantity of the contaminant in the starting material.

55. The method of claim 54, further comprising:
e) repeating steps (a) through (d) with a set of control samples containing various concentrations of the contaminant to form a dose curve; and
f) comparing the intensities of the quantum dot-competitor complex of the dose curve to the intensity obtained from the quantum dot-competitor complex from the starting material.
